(19) United States
(12) Patent Application Publication
(10) Pub. No.: US 2021/0008847 A1
(43) Pub. Date: Jan. 14, 2021

(54) ELASTIC OBJECT

(71) Applicants: YI-SHAN HSIAO, Changhua County (TW); HONG-HSI HSIAO, Changhua County (TW)

(72) Inventors: YI-SHAN HSIAO, Changhua County (TW); HONG-HSI HSIAO, Changhua County (TW)

(21) Appl. No.: 16/925,262

(22) Filed: Jul. 9, 2020

(30) Foreign Application Priority Data
Jul. 9, 2019 (TW) 108208933

(51) Int. Cl. B32B 25/10; B32B 5/02; B32B 7/09; B32B 7/12; B32B 25/14; A63B 23/16; A63B 21/02

(52) U.S. Cl. CPC B32B 25/10; B32B 5/024; B32B 7/09; B32B 7/12; B32B 25/14; A63H 33/18; A63B 21/028; B32B 2307/51; B32B 2250/02; B32B 2250/24; A63B 23/16

(57) ABSTRACT

An elastic object, adapted for cushioning, gripping, pressing or grasping uses, includes an elastic body and an elastic cloth layer wrapping and covering the exterior of the elastic body in a tight contacting manner. The elastic cloth layer is closely bonded on the elastic body in such a manner that the elastic body and the elastic cloth layer are deformed simultaneously in response to an applied external force, and that the elastic body and the elastic cloth layer restore their original shapes when the applied external force vanishes. Because the elastic body is covered and enclosed by the elastic cloth layer, it prevents human body from directly contacting the elastic body. Therefore, plasticizer or other chemicals of the elastic body will not be left on the user's hands, which ensures better safety and expands the applications of the elastic object with better usability and utility.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an elastic object and, in particular, to an elastic object having elastic resilience and restoration ability.

### Description of Related Arts

It is noted that elastic objects are commonly utilized in daily life. For instance, it may be utilized as sports equipment, medical and physical therapeutic equipment, cushioning equipment, toy, and etc. Elastic balls are common objects in the above fields. Specifically speaking, elastic ball may be made into a sports ball or physical therapeutic equipment for grasping or a toy with novel appearance for child to play. In addition, referring to Taiwan Pat. No. 105213984, “Cushioning Element,” its elastic resilience is utilized for cushioning purposes. This cushioning element mainly has a core elastic body which exterior is covered by a layer of chemical coating of polyurethane. Although such coating is able to serve the purpose of covering the core elastic object, the coating itself still contains plasticizer or other chemicals that would limit its usability. For example, it is not suitable for utilizing as physical therapeutic equipment, toy or sports equipment because it would cause discomfort while contacting human body. Hence, such conventional chemical coating technology has drawbacks in limited usability.

### SUMMARY OF THE PRESENT INVENTION

Hence, an object of the present invention is to provide an elastic object with better usability and utility.

Accordingly, the elastic object of the present invention is adapted for cushioning, pressing or grasping uses and includes an elastic body and an elastic cloth layer wrapping and covering an exterior of the elastic body, wherein the elastic cloth layer is closely contacted with the elastic body, such that the elastic body and the elastic cloth layer are adapted to be deformed simultaneously in response to an applied external force, and that the elastic body and the elastic cloth are adapted to restore their original shapes when the applied external force vanishes. Because the elastic body is covered and enclosed by the elastic cloth layer, it prevents human body from contacting the elastic body. Therefore, plasticizer or other chemicals contained on the elastic body will not be left on the user's hands, which ensures better safety and broader applications of the elastic object with better usability and utility.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an elastic object according to a preferred embodiment of the present invention.

FIG. 2 is a sectional view of the elastic object in original shape according to the above preferred embodiment of the present invention.

FIG. 3 is a sectional view of the deformed elastic object according to the above preferred embodiment of the present invention.

FIG. 4 is another perspective view of the elastic object according to the above preferred embodiment of the present invention.

### DETAILED DESCRIPTION OF THE PREFERRED EMBODIMENT

The following disclosure is to illustrate implementations of the present invention through specific embodiments, so that those skilled in the art can easily understand other advantages and functions of the present invention through the disclosure.

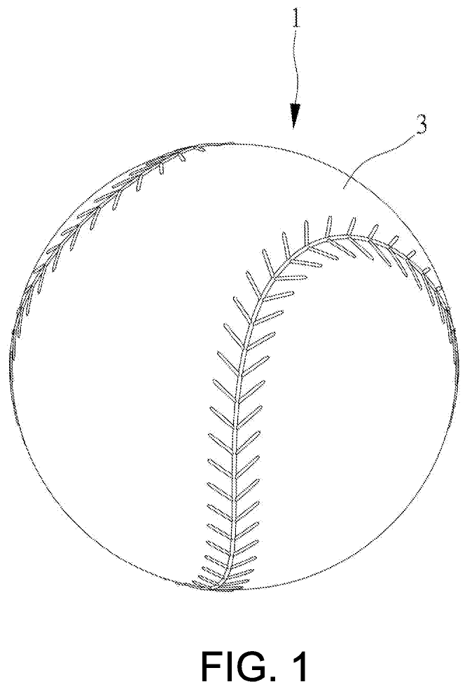

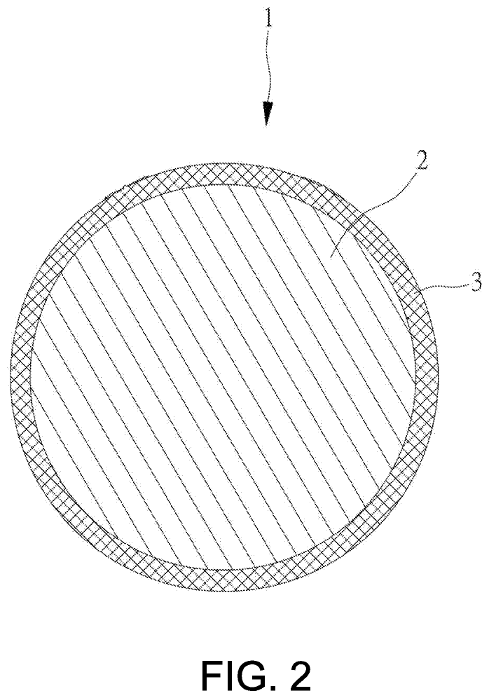

Referring to FIGS. 1-2, an elastic object 1 according to a preferred embodiment of the present invention is illustrated, which is adapted for cushioning, gripping, pressing and/or grasping uses. The elastic object 1 is implemented into a bouncy ball in the present embodiment, which includes a ball shaped elastic body 2 and at least an elastic cloth layer 3 wrapping and covering an exterior of the elastic body 2 completely. The elastic body 2 is mainly made from a combination of thermoplastic rubber or polyurethane resin with a material having releasing ability that it has a relatively great elastic resilience and restoration ability as well as a predetermined stickiness to a certain extent for tight bonding attachment with the elastic cloth layer 3. The elastic cloth layer 3 may be formed through sewing a plurality pieces of cloth and be adapted for forming various exterior patterns, so as for enhancing the appearance and aesthetics thereof. The elastic cloth layer 3 may be made of Lycra fabric, nylon elastic fabric, polyester fabric, and etc., and be sewn to wrap and cover the exterior of the elastic body 2 in a close and tight contacting manner.

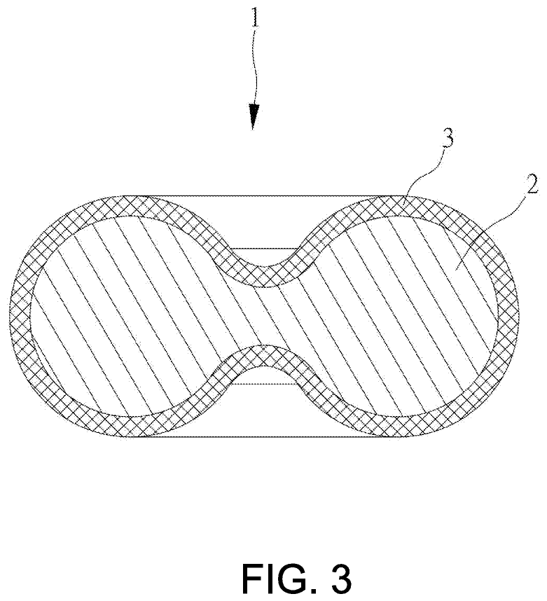

Referring to FIG. 3, when the elastic object 1 is pressed up and down by fingers, the elastic body 2 and the elastic cloth layer 3 are simultaneously deformed corresponding to the applied external force. When the applied external force vanishes, the elastic body 2 and the elastic cloth 3 would restore to their original shapes simultaneously. It is worth further illustrating that, because the elastic cloth layer 3 has an elasticity in accordance with the elastic body 2, when the elastic body 2 is deformed due to bearing an external force, the elastic cloth layer 3 deforms with the elastic body 2 at the same time while the elastic cloth layer 3 remains in tight and close contact with the elastic body 2 as an integral body. In other words, the hand contacting elastic cloth layer 3 would not affect the degree of deformation of the elastic body 2. Besides, the elastic body 2 is covered, wrapped and enclosed by the elastic cloth layer 3, such that the elastic cloth layer 3 can significantly prevent human body from contacting the chemicals of the elastic body 2. More specifically speaking, when a person presses the elastic object 1 with his/her bare hand, his/her hand merely contacts the elastic cloth 3, so that plasticizer or other chemicals on the elastic body 2 will not pollute or be left on his/her hand. Therefore, it is safer to use and also grants a wider application field for the elastic object 1 of the present invention, such as a squeeze ball for physical therapy, cushioning equipment, toy bouncy ball, personal relaxing products, and etc. Hence, the elastic object 1 of the present invention substantially has better usability and utility.

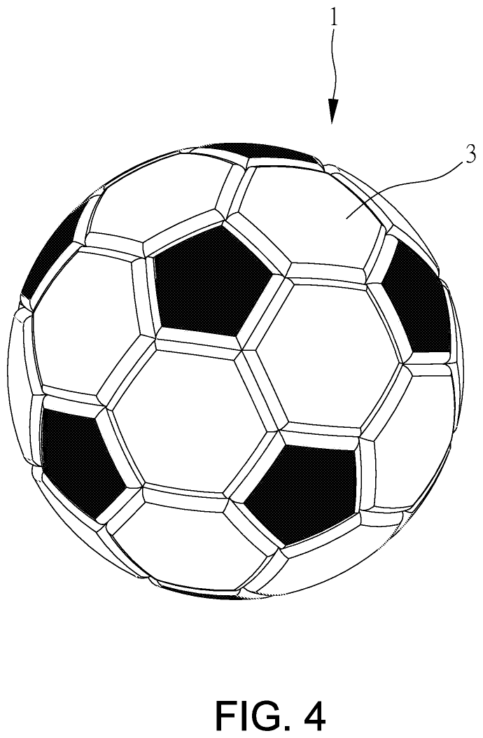

Referring to FIG. 4, the variability of the design of the elastic cloth 3 is quite high. For example, it may be designed to have an appearance of soccer ball, so that the ball shaped elastic object becomes an elastic soccer ball. For another example as illustrated in FIG. 1, the appearance of the elastic object 1 can be made as an elastic baseball. Hence, the elastic object 1 of the present invention can form various items easily through various exterior designs of the elastic cloth layer 3, so as to provide a more preferable designability. In addition, both the elastic body 2 and the elastic cloth layer 3 of the elastic object 1 of the present invention are washable, which facilitates the user to maintain the exterior cleaning thereof.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An elastic object, adapted for cushioning, gripping, pressing, and grasping uses, comprising an elastic body and an elastic cloth layer wrapping and covering an exterior of said elastic body completely in a tightly contacting manner, wherein said elastic cloth layer is closely bonded on said elastic body to form an integral body, such that said elastic body and said elastic cloth layer are capable of being deformed simultaneously in response to an applied external force, and that said elastic body and said elastic cloth layer restore the original shapes thereof when the applied external force vanishes.

2. The elastic object, as recited in claim 1, wherein said elastic cloth layer is sewn to wrap and cover the exterior of said elastic body.

3. The elastic object, as recited in claim 2, wherein said elastic cloth is formed through sewing a plurality pieces of cloth.

4. The elastic object, as recited in claim 2, wherein said elastic cloth layer is adapted for forming various patterns on the exterior thereof, so as for enhancing an appearance of said elastic object.

5. The elastic object, as recited in claim 1, wherein said elastic body, having a ball shape, is made of a first material selected from the group consisting of a thermoplastic rubber, a polyurethane resin, and a combination of the thermoplastic rubber and the polyurethane resin, with a second material having releasing ability, to have an elastic resilience and restoration ability and a predetermined stickiness for tight bonding with said elastic cloth layer.

6. The elastic object, as recited in claim 2, wherein said elastic body, having a ball shape, is made of a first material selected from the group consisting of a thermoplastic rubber, a polyurethane resin, and a combination of the thermoplastic rubber and the polyurethane resin, with a second material having releasing ability, to have an elastic resilience and restoration ability and a predetermined stickiness for tight bonding with said elastic cloth layer.

7. The elastic object, as recited in claim 3, wherein said elastic body, having a ball shape, is made of a first material selected from the group consisting of a thermoplastic rubber, a polyurethane resin, and a combination of the thermoplastic rubber and the polyurethane resin, with a second material having releasing ability, to have an elastic resilience and restoration ability and a predetermined stickiness for tight bonding with said elastic cloth layer.

8. The elastic object, as recited in claim 4, wherein said elastic body, having a ball shape, is made of a first material selected from the group consisting of a thermoplastic rubber, a polyurethane resin, and a combination of the thermoplastic rubber and the polyurethane resin, with a second material having releasing ability, to have an elastic resilience and restoration ability and a predetermined stickiness for tight bonding with said elastic cloth layer.

9. The elastic object, as recited in claim 1, wherein said elastic cloth layer is made of a fabric layer selected from the group consisting of Lycra fabric, nylon elastic and polyester fabric.

10. The elastic object, as recited in claim 2, wherein said elastic cloth layer is made of a fabric layer selected from the group consisting of Lycra fabric, nylon elastic and polyester fabric.

11. The elastic object, as recited in claim 3, wherein said elastic cloth layer is made of a fabric layer selected from the group consisting of Lycra fabric, nylon elastic and polyester fabric.

12. The elastic object, as recited in claim 4, wherein said elastic cloth layer is made of a fabric layer selected from the group consisting of Lycra fabric, nylon elastic and polyester fabric.

13. The elastic object, as recited in claim 5, wherein said elastic cloth layer is made of a fabric layer selected from the group consisting of Lycra fabric, nylon elastic and polyester fabric.

14. The elastic object, as recited in claim 6, wherein said elastic cloth layer is made of a fabric layer selected from the group consisting of Lycra fabric, nylon elastic and polyester fabric.

15. The elastic object, as recited in claim 7, wherein said elastic cloth layer is made of a fabric layer selected from the group consisting of Lycra fabric, nylon elastic and polyester fabric.

16. The elastic object, as recited in claim 8, wherein said elastic cloth layer is made of a fabric layer selected from the group consisting of Lycra fabric, nylon elastic and polyester fabric.

17. The elastic object, as recited in claim 1, wherein said elastic body and said elastic cloth layer are washable.

18. The elastic object, as recited in claim 5, wherein said elastic body and said elastic cloth layer are washable.

19. The elastic object, as recited in claim 9, wherein said elastic body and said elastic cloth layer are washable.

20. The elastic object, as recited in claim 13, wherein said elastic body and said elastic cloth layer are washable.
